(19) United States
(12) Patent Application Publication
(10) Pub. No.: US 2009/0225071 A1
(43) Pub. Date: Sep. 10, 2009

(54) Image display system with light source controlled by non-binary data

(76) Inventors: Kazuma Arai, Tokyo (JP); Yoshihiro Maeda, Tokyo (JP); Fusao Ishil, Menlo Park, CA (US); Hirotoshi Ichikawa, Tokyo (JP)

Correspondence Address: BO-IN LIN, 13445 MANDOLI DRIVE, LOS ALTOS HILLS, CA, 94022, US

(21) Appl. No.: 12/383,619

(22) Filed: Mar. 25, 2009

Related U.S. Application Data
(62) Division of application No. 11/823,942, filed on Jun. 29, 2007.
Application No. 11/823,942 is a continuation-in-part of application No. 11/121,543, filed on May 4, 2005, now Pat. No. 7,268,932.
Application No. 11/121,543 is a continuation-in-part of application No. 10/698,620, filed on Nov. 1, 2003, now abandoned.
Application No. 10/698,620 is a continuation-in-part of application No. 10/699,140, filed on Nov. 1, 2003, now Pat. No. 6,862,127.
Application No. 10/699,140 is a continuation-in-part of application No. 10/699,143, filed on Nov. 1, 2003, now Pat. No. 6,903,860.

(51) Int. Cl. G09G 5/00

(52) U.S. Cl. 345/214

(57) ABSTRACT

An image display system for displaying an image according to an input image signal, and comprises a light source for emitting an illumination light; a data converting circuit for receiving and converting the input image signal into non-binary data; a spatial light modulator for receiving and applying the non-binary data for modulating the illumination light; a light source control circuit for applying the non-binary data in coordination with the spatial light modulator for controlling the light source.

### CROSS REFERENCE TO RELATED APPLICATIONS

This application is a divisional application of a pending U.S. patent application Ser. No. 11/823,942 filed on Jun. 29, 2007. The application Ser. No. 11/823,942 is a Continuation in Part (CIP) Application of a U.S. patent application Ser. No. 11/121,543 filed on May 4, 2005, now issued into U.S. Pat. No. 7,268,932. The application Ser. No. 11/121,543 is a Continuation in Part (CIP) Application of three previously filed Applications. These three Applications are Ser. No. 10/698,620 filed on Nov. 1, 2003; Ser. No. 10/699,140 filed on Nov. 1, 2003 and issued into U.S. Pat. No. 6,862,127; and Ser. No. 10/699,143 filed on Nov. 1, 2003 and issued into U.S. Pat. No. 6,903,860 by one of the Applicant of this Patent Applications. The disclosures made in these Patent Applications are hereby incorporated by reference in this Patent Application.

### BACKGROUND OF THE INVENTION

1. Technical Field of the Invention

The present invention relates generally to image display device. More particularly, this invention relates to an image display device implemented with an adjustable light source controlled by non-binary data.

2. Description of the Related Art

Even though there have been significant advances made in recent years in the technology of implementing electromechanical micromirror devices as spatial light modulators (SLM), there are still limitations and difficulties when these are employed to display high quality images. Specifically, when the display images are digitally controlled, the quality of the images is adversely affected because the images are not displayed with a sufficient number of gray scale gradations.

Electromechanical mirror devices are drawing a considerable amount of interest as spatial light modulators (SLM). The electromechanical mirror device consists of a mirror array arranging a large number of mirror elements. In general, the number of mirror elements range from 60,000 to several millions and are arranged on the surface of a substrate in an electromechanical mirror device.

Refer to FIG. 1A for a digital video system 1 as disclosed in relevant U.S. Pat. No. 5,214,420, which includes a display screen 2. A light source 10 is used to generate light energy to illuminate display screen 2. Light 9 is further concentrated and directed toward lens 12 by mirror 11. Lens 12, 13, and 14 serve a combined function as a beam columnator to direct light 9 into a column of light 8. A spatial light modulator 15 is controlled by a computer through data transmitted over data cable 18 to selectively redirect a portion of the light from path 7 toward lens 5 to display on screen 2. The SLM 15 has a surface 16 that includes switchable reflective elements, e.g., micro-mirror devices 32 with elements 17, 27, 37, and 47 as reflective elements attached to a hinge 30, as shown in FIG. 1B. When element 17 is in one position, a portion of the light from path 7 is redirected along path 6 to lens 5 where it is enlarged or spread along path 4 to impinge the display screen 2 so as to form an illuminated pixel 3. When element 17 is in another position, light is not redirected toward display screen 2 and hence pixel 3 would be dark.

Most of the conventional image display devices, such as the devices disclosed in U.S. Pat. No. 5,214,420, are implemented with a dual-state mirror control that controls the mirrors to operate in either an ON or OFF state. The quality of an image display is limited due to the limited number of gray scale gradations. Specifically, in a conventional control circuit that applies a PWM (Pulse Width Modulation), the quality of the image is limited by the LSB (least significant bit) or the least pulse width, since the control is related to either the ON or OFF state. Since the mirror is controlled to operate in either an ON or OFF state, the conventional image display apparatuses have no way of providing a pulse width to control the mirror that is shorter than the LSB. The lowest intensity of light, which determines the smallest gradation to which brightness can be adjusted when adjusting the gray scale, is the light reflected during the period corresponding to the smallest pulse width. The limited gray scale gradation due to the LSB limitation leads to a degradation of the quality of the display image.

In FIG. 1C, a circuit diagram of a control circuit for a micro-mirror according to U.S. Pat. No. 5,285,407 is presented. The control circuit includes memory cell 32. Various transistors are referred to as “M*” where * designates a transistor number and each transistor is an insulated gate field effect transistor. Transistors M5, and M7 are p-channel transistors; transistors, M6, M8, and M9 are n-channel transistors. The capacitances, C1 and C2, represent the capacitive loads presented to memory cell 32. Memory cell 32 includes an access switch transistor M9 and a latch 32a, which is the basis of the Static Random Access switch Memory (SRAM) design. All access transistors M9 in a row receive a DATA signal from a different bit-line 31a. The particular memory cell 32 to be written is accessed by turning on the appropriate row select transistor M9, using the ROW signal functioning as a word-line. Latch 32a is formed from two cross-coupled inverters, M5/M6 and M7/M8, which permit two stable states. State 1 is Node A high and Node B low and state 2 is Node A low and Node B high.

The dual-state switching, as illustrated by the control circuit, controls the micromirrors to position either at an ON or an OFF orientation, as that shown in FIG. 1A. The brightness, i.e., the gray scales of display for a digitally control image system, is determined by the length of time the micromirror stays at an ON position. The length of time a micromirror is controlled at an ON position is in turned controlled by a multiple bit word. For simplicity of illustration, FIG. 1D shows the “binary time intervals” when controlled by a four-bit word. As shown in FIG. 1D, the time durations have relative values of 1, 2, 4, 8 that in turn define the relative brightness for each of the four bits, where 1 is for the least significant bit and 8 is for the most significant bit. According to the control mechanism as shown, the minimum controllable differences between gray scales is a brightness represented by a “least significant bit” that maintains the micromirror at an ON position.

When adjacent image pixels are shown with a great degree of difference in the gray scales, due to a very coarse scale of controllable gray scale, artifacts are shown between these adjacent image pixels. That leads to image degradations. The image degradations are especially pronounced in the bright areas of display, where there are “bigger gaps” between gray scales of adjacent image pixels. For example, it can be observed in an image of a female model that there are artifacts shown on the forehead, the sides of the nose and the upper arm. The artifacts are generated by technical limitations in that the digitally controlled display does not provide sufficient gray scales. Thus, in the bright areas of the display, the adjacent pixels are displayed with visible gaps of light intensities.

As the micromirrors are controlled to have a fully on and fully off position, the light intensity is determined by the length of time the micromirror is at the fully on position.

In order to increase the number of gray scale gradations of a display, the switching speed of the micromirror must be increased such that the digital control signals can be increased to a higher number of bits. However, when the switching speed of the micromirrors is increased, a stronger hinge is necessary for the micromirror to sustain the required number of operational cycles for a designated lifetime of operation. In order to drive the micromirrors supported on a further strengthened hinge, a higher voltage is required. In this case, the higher voltage may exceed twenty volts and may even be as high as thirty volts. A micromirror manufacturing process applying the CMOS (Complementary Metal Oxide Semiconductor) technologies would probably produce micromirrors that would not be suitable for operation at this higher range of voltages, and therefore, DMOS (Double diffused Metal Oxide Semiconductor) micromirror devices may be required in this situation. In order to achieve a higher degree of gray scale control, a more complicated manufacturing process and larger device areas are necessary when a DMOS micromirror is implemented. Conventional modes of micromirror control are therefore facing a technical challenge in that gray scale accuracy has to be sacrificed for the benefit of a smaller and more cost effective micromirror display, due to the operational voltage limitations.

There are many patents related to light intensity control. These Patents include U.S. Pat. Nos. 5,589,852, 6,232,963, 6,592,227, 6,648,476, and 6,819,064. There are further patents and patent applications related to different shapes of light sources. These Patents includes U.S. Pat. Nos. 5,442,414, 6,036,318 and Application 20030147052. The U.S. Pat. No. 6,746,123 discloses special polarized light sources for preventing light loss. However, these patents and patent application do not provide an effective solution to overcome the limitations caused by insufficient gray scales in the digitally controlled image display systems.

Furthermore, there are many patents related to spatial light modulation that includes U.S. Pat. Nos. 20,25,143, 2,682,010, 2,681,423, 4,087,810, 4,292,732, 4,405,209, 4,454,541, 4,592,628, 4,615,595, 4,728,185, 4,767,192, 4,842,396, 4,907,862, 5,214,420, 5,287,096, 5,506,597, 5,489,952, 6,064,366, 6,535,319, and 6,880,936. However, these inventions have not addressed and provided direct resolutions for a person of ordinary skill in the art to overcome the above-discussed limitations and difficulties.

Therefore, a need still exists in the art of image display systems applying digital control of a micromirror array as a spatial light modulator to provide new and improved systems such that the above-discussed difficulties can be resolved.

### SUMMARY OF THE INVENTION

An aspect of the present invention is to provide a color display device implemented with a spatial light modulator and an adjustable light source. A controller is employed to control the light source and the spatial light modulator by applying non-binary data generated by converting the input image signal. The control processes apply the non-binary data to simultaneously control the light source and the spatial light modulator thus achieving increased gray scale resolutions for improving the quality of the display images.

The first exemplary embodiment of the present invention is an image display system for displaying an image according to an input image signal, and comprises a light source for emitting an illumination light; a data converting circuit for receiving and converting the input image signal into non-binary data; a spatial light modulator for receiving and applying the non-binary data for modulating the illumination light; a light source control circuit for applying the non-binary data in coordination with the spatial light modulator for controlling the light source.

The second exemplary embodiment of the present invention is an image display system for displaying an image according to an input image signal, and comprises a light source for emitting an illumination light; a data conversion circuit for receiving and converting several bits of input image data into an output data; a spatial light modulator for modulating the illumination light; a control circuit for receiving and applying the output signal for controlling the light source and the spatial light modulator.

The third exemplary embodiment of the present invention is an image display system for displaying an image according to an input image signal, and comprises a light source for emitting an illumination light; a data conversion circuit for receiving and converting an input image data into non-binary data; a spatial light modulator for receiving and applying the non-binary data for modulating the illumination light; a control circuit for receiving and applying the non-binary data to control the spatial light modulator; and a light source control circuit receives and applies a clock signal synchronous with a reference clock signal used for converting the input image data for controlling the light source.

A fourth exemplary embodiment of the present invention is an image display device for displaying images according to inputted image signals. The image display device comprises a light source for supplying illuminating light, a spatial light modulator(SLM) comprises a plurality of deflective light modulation elements for deflecting the illuminating light according to a deflection state, a data converting circuit for converting at least N consecutive bits (N is a positive integer) of the image signal to non-binary data and a light source control circuit receives and applies the non-binary data to control the light source to emit the illuminating light.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

The present invention is described in detail below with reference to the following Figures.

FIG. 1A is a functional block diagram for showing the configuration of a projection apparatus according to a conventional technique;

FIG. 1B is a top view for showing the configuration of a mirror element of the projection apparatus according to a conventional technique;

FIG. 1C is a circuit diagram for showing the configuration of the drive circuit of a mirror element of the projection apparatus according to a conventional technique;

FIG. 1D is a timing diagram for showing the format of image data used in the projection apparatus according to a conventional technique;

FIG. 2A shows a bit structural diagram implemented by a control process according to a prior art scheme and FIGS. 2B and 2C shows modified bit structures for a control process to operate a mirror device with an intermediate state control of this invention.

FIG. 3A shows a control system using non-binary data.

FIG. 3B is a cross-sectional view showing a deflective modulation element arranged in an SLM in the form of an array.

FIG. 4A shows a bit structure mapped into a timing diagram for implementing a control process of a prior art scheme and FIGS. 4B and 4C show the improved bit structure mapped into timing diagram for implementing a PWM control system using non-binary data of this invention.

FIG. 5 shows a functional block diagram for illustrating a method of controlling the illumination of this invention.

FIG. 6A shows a functional block diagram of an SLM, and FIG. 6B shows a control circuit diagram that executes a Digital Signal Control scheme.

FIGS. 7A and 7B show the data and corresponding display states of another preferred embodiment, with the N bits as the difference between the number of bits of incoming image signal and the number of bits to display in gray scale.

FIG. 8A shows a pulse width diagram of a control signal for an SLM, with corresponding light intensity in a frame period;

FIG. 8B shows a control circuit diagram that implements an illuminating light from a semiconductor laser source or LED light source.

FIGS. 9 to 12 show the circuit diagrams of different control circuit diagrams for carrying out different gray scale control schemes as embodiments of this invention.

FIG. 13 shows an optical configuration example of a single-panel image display device according to a preferred embodiment of the present invention.

FIGS. 14A, 14B, and 14C show an optical configuration example of a two-panel image display device according to a preferred embodiment of the present invention.

FIG. 15 shows an optical configuration example of a three-panel image display device according to a preferred embodiment of the present invention.

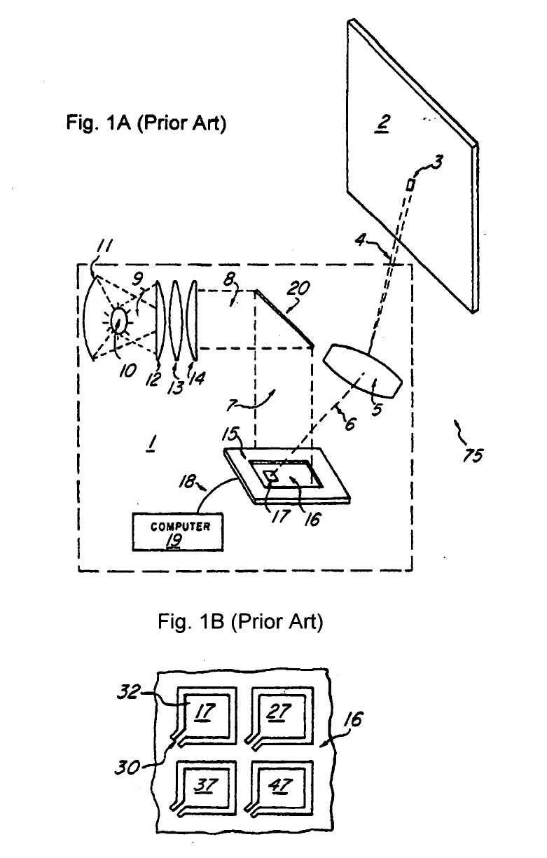

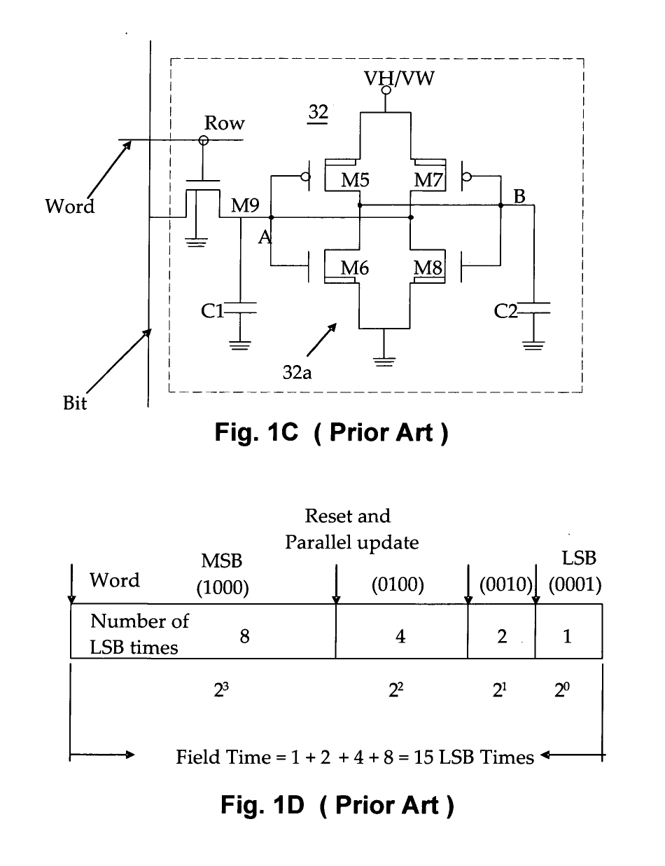

### DESCRIPTION OF THE PREFERRED EMBODIMENTS

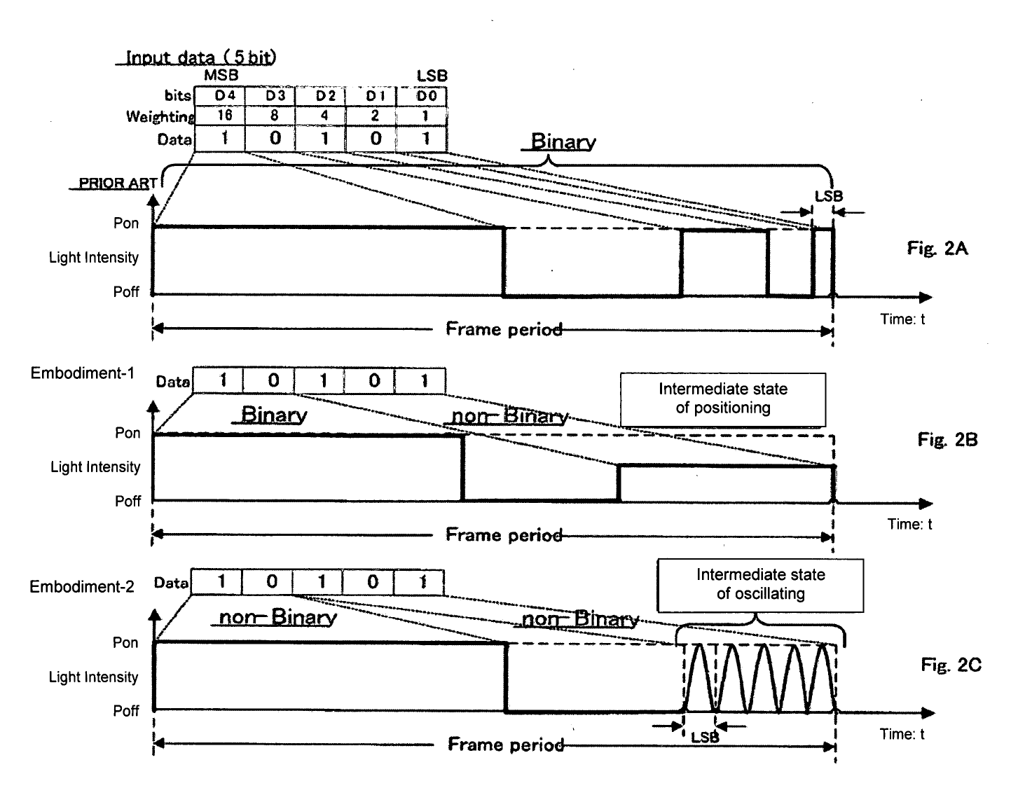

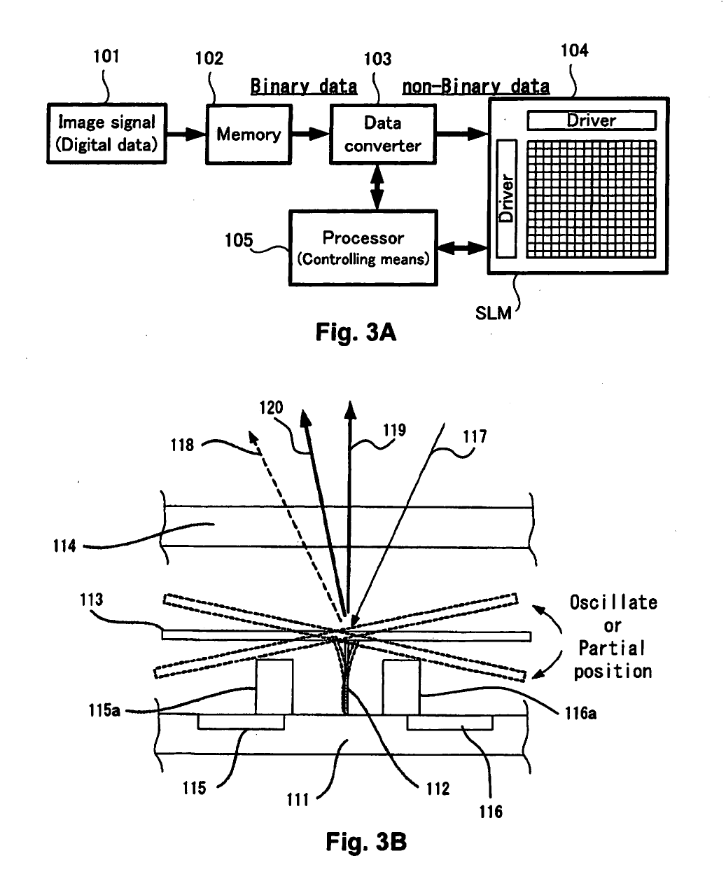

FIG. 2A shows a prior art scheme with input data of five bits as binary data of either zero or one, with the least significant bit having a weighting factor of one and the most significant bit (MSB) having a weighting factor of 16, to control the frame period. In contrast, FIGS. 2B and 2C are diagrams for showing embodiments of this invention that include a data converter, as that shown in FIG. 3A below, to convert a binary input data into non-binary data to control the oscillation or positioning of the mirrors in an SLM, to further increase the gray scales of an image display device. The non-binary data is applied, as shown in FIG. 2B, to control the mirrors to have an intermediate position. In FIG. 2C, the non-binary data is applied to control the mirrors to have an intermediate state of oscillation. As will be further discussed below, the image display device therefore includes a controller to receive non-binary data to carry out an oscillation control or a positioning control.

An image display device according to a preferred embodiment of the present invention is an image display device using a spatial light modulator (SLM), and comprises: illuminating light incident to a deflective modulation element provided in the SLM; the deflective modulation element for deflecting the illuminating light, depending on the deflection state of the element itself; binary data according to an image signal; a data converting unit for converting at least N consecutive bits of the binary data into non-binary data; and a controlling unit for controlling the deflective modulation element with the non-binary data.

With the image display device having such a configuration, a weaker projected light, than that obtained from a stationary deflection state in a fully ON direction, may be obtained by using an oscillating state or a stationary intermediate state as the deflection state of the deflective modulation element. Additionally, the oscillating state can be controlled by the application of non-binary data. As a result, a display of higher gray scales can be achieved.

FIG. 2A shows a control example of projected light in one frame period in a conventional image display device using an SLM having a deflective modulation element for deflecting illuminating light in a fully ON or a fully OFF stationary deflection direction. As shown in FIG. 2A, with the conventional image display device, projected light in one frame period is controlled by controlling the deflection direction of the deflective modulation element according to the values of bits from LSB to MSB in binary data, and weighting factors respectively pre-assigned to the bits from LSB to MSB. Projected light is conventionally controlled by using binary data, which is the unchanged input data.

FIG. 2B shows projected light in one frame period in an image display device according to a preferred embodiment of the present invention, which uses an SLM having a deflective modulation element for defecting illuminating light in a fully ON, a fully OFF, or an intermediate stationary deflection direction. The intermediate direction is a stationary direction between the fully ON direction and the fully OFF direction. The state of the intermediate stationary deflection direction is also referred to as an intermediate state.

As shown in FIG. 2B, with the image display device according to this preferred embodiment, at least N consecutive bits of binary data, which is inputted data, is converted into non-binary data, and the remaining bits are left unchanged as binary data. In the example shown in FIG. 2B, the lowest-order 3 bits of binary data, are converted into non-binary data, and the remaining highest-order 2 bits are left unchanged as binary data. The state of the deflection direction of the deflective modulation element is controlled to be fully ON or fully OFF, according to the values of the bits left unchanged as the binary data and the weighting factors pre-assigned to these bits, and controlled to be in the intermediate stationary deflection direction, according to the converted non-binary data. Specifically, in this preferred embodiment, projected light is controlled by converting part of the inputted data, binary data, into non-binary data and by using the non-binary data and the remaining binary data.

FIG. 2C shows projected light in one frame period in an image display device according to a preferred embodiment of the present invention, which uses an SLM having a deflective modulation element for deflecting illuminating light in a fully ON direction, a fully OFF direction, or an oscillating state. The oscillating state is a state where the deflection direction temporally varies between the fully ON direction and the fully OFF direction. The oscillating state is also referred to as an intermediate state.

As shown in FIG. 2C, in the image display device according to this preferred embodiment, the entire imputed binary data is converted into non-binary data. Then, the deflection direction of the deflective modulation element is controlled to be fully ON, fully OFF direction, or in the oscillating state, according to the converted non-binary data. More specifically, the deflection direction of the deflective modulation element is controlled to be continually fully ON or fully OFF by using non-binary data converted from consecutive binary data, and controlled to be continually in the oscillating state by using non-binary data converted from the remaining consecutive binary data. In this preferred embodiment, projected light is controlled by converting inputted binary data into non-binary data and by using the non-binary data.

In the control example shown in FIG. 2B, the control of the intermediate state can be replaced with the control of the oscillating state shown in FIG. 2C. Or, in the control example shown in FIG. 2C, the control of the intermediate state can be replaced with the control of the state of the intermediate direction shown in FIG. 2B.

FIG. 3A is a functional block diagram illustrating a control system. The image signal 101 is received into the controller as digital data and stored into a memory 102. The digital image data is then read into a data converter 103 to convert a part of or all of the digital image data into non-binary data for inputting to a spatial light modulator (SLM) 104 with drivers to receive the signal to control the deflective micromirrors. The controller further includes a controlling processor 105 for controlling the data converter 103 and the SLM 104.

The above-described image display device according to the preferred embodiment of the present invention further comprises a light source to project a light which is deflected by the deflective modulation element. The light reflected by the deflective modulation element has a cross-section of a non-uniform intensity distribution, wherein a gray scale display can be made by using the deflection state of the deflective modulation element.

With the image display device implement the system configuration and control process, the projected light has a cross-section of a non-uniform intensity distribution is further used, wherein the amount of output light with less intensity can be extracted for controlling and projecting images with a higher level of gray scales.

In FIG. 3A, a data converter 103 converts at least N consecutive bits of binary data into non-binary data under the control of a processor 105. An SLM 104 drives a deflective modulation element under the control of the processor 105 according to non-binary data, converted from part of the binary data by the data converter 103, and the remaining binary data, or according to non-binary data converted from entirety of the binary data, as described above. In this way, the SLM 104 can perform, the controls shown in FIG. 2B or FIG. 2C.

FIG. 3B is a cross-sectional view showing an example of a deflective modulation element arranged in the SLM 104 in the form of a two-dimensional array. In FIG. 3B, a mirror element, which is a deflective modulation element, comprises a deflectable mirror 113 supported on a hinge 112 on a substrate 111. The mirror 113 is protected by a cover glass 114. On the substrate 111, an OFF electrode 115, an OFF stopper 115a, an ON electrode 116, and an ON stopper 116a are arranged symmetrically about the hinge 112.

By the application of a predetermined potential, the OFF electrode 115 tilts the mirror 113 to a position in which the mirror 113 contacts the OFF stopper 115a with a Coulomb force between the OFF electrode 115 and the mirror 113. Consequently, incident light 117 is reflected by the mirror 113 towards the light path 118 of the OFF position, is not aligned with the optical axis of the projection optical system. The deflection state of the mirror element in this position is referred to as a fully OFF state or simply as an OFF state.

Similarly, with the application of a predetermined potential, a Coulomb force is generated, and the ON electrode 116 tilts the mirror 113 to a position in which the mirror 113 contacts the ON stopper 116a. Consequently, incident light 117 is reflected by the mirror 113 towards the light path 119 of the ON position, which is aligned with the optical axis of the projection optical system. The deflection state of the mirror element in this position is referred to as a fully ON state or merely as an ON state.

Stopping the application of the predetermined potential to the OFF electrode 115 or the ON electrode 116 causes the mirror 113 to start a free oscillation with the elasticity of the hinge 112. As a result, the incident light 117 is reflected by the mirror 113 towards a light path (for example, a light path 120), which varies, with time, between the OFF light path 118 and the ON light path 119. The deflection state of the mirror element in this case is referred to as an oscillating state.

By applying a first potential and a second potential, lower than the first potential, to the OFF electrode 115 and the ON electrode 116, respectively, the OFF the mirror 113 is tilted with Coulomb force into a position on the side of the OFF electrode 115 but just before contacting the OFF stopper 115a. Since Coulomb force is exerted also between the mirror 113 and the ON electrode 116 at this time, the mirror 113 stops in a position before contacting the OFF stopper 115a. As a result, the incident light 117 is reflected by the mirror 113 towards a stationary light path (for example, the light path 120) between the OFF light path 118 and the ON light path 119. The deflection state of the mirror element in this position is referred to as a state of an intermediate direction.

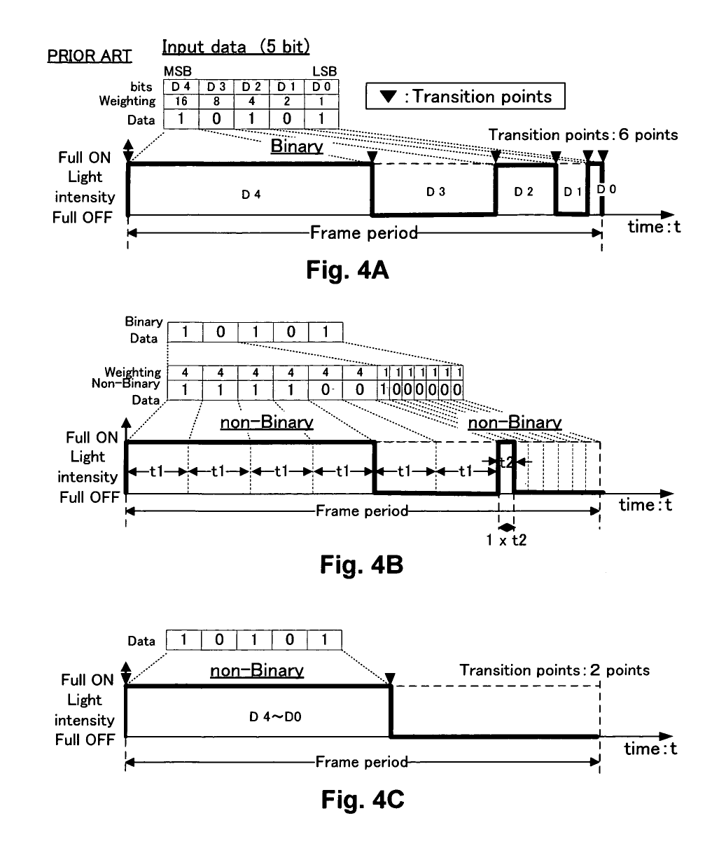

FIG. 4A shows a prior art scheme for a PWM control using binary data, and FIGS. 4B and 4C show PWM control systems using non-binary data.

If PWM control is performed by using non-binary data, an image display device according to a preferred embodiment of the present invention can be also configured as follows. Specifically, the image display device using a spatial light modulator (SLM) comprises: illuminating light incident to a deflective modulation element provided in the SLM; a deflective modulation element for deflecting the illuminating light, depending on at least two deflection states of the element itself; binary data according to an image signal; a data converting unit for converting at least N consecutive bits of the binary data into non-binary data; and a controlling unit for controlling the deflective modulation element with the non-binary data, wherein the controlling unit controls the deflective modulation element so that the deflection state of the deflective modulation element is maintained continuously.

With the image display device having such a configuration, the following effects can also be expected when non-binary data is applied to a stationary deflection direction of the deflective modulation element:

1) An image display can be made by using sub-frames having the same display time, whereby the control unit can process the sub-frame data with a uniform throughput requirement (see FIGS. 4B and 4C).

2) A desired gray scale can be achieved in one or more continuing deflection states of the deflective modulation element, whereby the number of times the deflection states are switched, which can cause an error of a gray scale display, can be reduced or made uniform. Accordingly, the accuracy of gray scale display can be improved (see FIGS. 4B and 4C).

FIG. 4A shows an example of PWM control performed with binary data in one frame period in a conventional image display device, using an SLM having a deflective modulation element for deflecting illuminating light in a fully ON direction or a fully OFF direction, and also shows an example of controlling the projected light shown in FIG. 2A. As shown in FIG. 4A, with the conventional image display device, one frame period is divided into a plurality of sub-frame periods having different times according to weighting factors pre-assigned to the bits from the LSB to MSB of inputted binary data, and the deflective modulation element is controlled to be in the fully ON direction or the fully OFF direction, according to the value of a corresponding bit in each of the sub-frame periods. With such a control, the deflection state switches six times (from the fully OFF direction to the fully ON direction, or vice versa), if the inputted binary data is “10101” of 5 bits shown in FIG. 4A (see Transition points of FIG. 4A).

In contrast, FIG. 4B shows an example of PWM control performed with non-binary data in one frame period in an image display device according to a preferred embodiment of the present invention, which uses an SLM having a deflective modulation element for deflecting illuminating light in a fully ON direction or a fully OFF direction, and also shows an example of controlling the projected light. With the image display device according to this preferred embodiment, the inputted binary data is converted into non-binary data. More specifically, data of the highest-order 2 bits in 5-bit binary data is converted into a bit string of 6 bits, all of which have a weighting factor of 4, and data of the remaining lowest-order 3 bits in the 5-bit binary data is converted into a bit string of 7 bits, all of which have a weighting factor of 1. Data obtained by converting the inputted binary data into data with one or more bit strings, where the weighting factors of bits are equal, is referred to as non-binary data.

Then, one frame period is divided into 13 sub-frame periods, composed of 6 sub-frame periods having a time t1, which corresponds to the weighting factor of 4, and 7 sub-frame periods having a time t2, which corresponds to the weighting factor of 1, according to the weighting factors of the bits of the non-binary data. The deflective modulation element is then controlled to continuously be in a fully ON direction or fully OFF direction, according to the value of the corresponding bit in the non-binary data in each of the sub-frame periods. With such a control, the deflection state is switched 4 times in the image display device according to this preferred embodiment, which is less than in the conventional image display device shown in FIG. 4A.

FIG. 4C shows another example of PWM control performed with non-binary data in one frame period in an image display device according to a preferred embodiment of the present invention, which uses an SLM having deflective modulation elements for deflecting illuminating light in a fully ON direction or the fully OFF direction, and also shows another example of controlling the projected light. Similar to the example show in FIG. 4B, the inputted binary data is converted into non-binary data. More specifically, the inputted binary data of 5 consecutive bits is converted into a bit string where the weighting factors of all of bits are equal (not shown). For example, the binary data is converted into a bit string where the weighting factors of all of bits are 1. Then, one frame period is divided into a plurality of sub-frame periods according to the weighting factors of the bits of the non-binary data, and the deflective modulation element is controlled to continuously be in a fully ON direction or fully OFF direction, according to the value of the corresponding bit in the non-binary data in each of the sub-frame periods. With such a control, the deflection state is switched twice (see Transition points of FIG. 4C), which is less than in the conventional image display device shown in FIG. 4A.

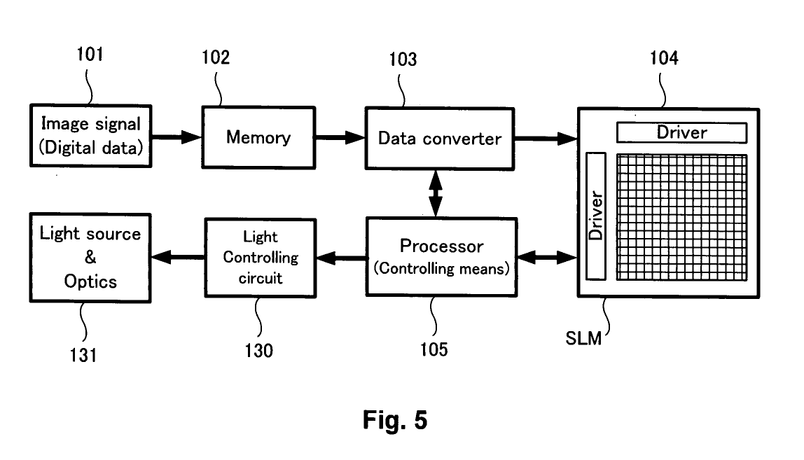

FIG. 5 is a control block diagram for illustrating a method to control illumination.

The above described image display device, according to the preferred embodiment of the present invention, can be also configured to further comprise a light source controlling unit for controlling the light intensity, the light emission cycle, or the light emission state, such as the intensity distribution, etc. of the illuminating light.

With the image display device having such a configuration, the intensity of projected light can be decreased when the deflective modulation element is in the oscillating state or in the state of the intermediate direction, thereby implementing a higher gray scale.

FIG. 5 shows a system configuration example of the image display device having such a configuration. The system configuration example shown in FIG. 5 is a configuration implemented by adding a light source controlling circuit 130, and a light source/optical system 131 to the system configuration example shown in FIG. 3A. The light source controlling circuit 130 controls the light intensity, the light emission cycle, or the light emission state, such as the intensity distribution, etc. of illuminating light irradiated from the light source.

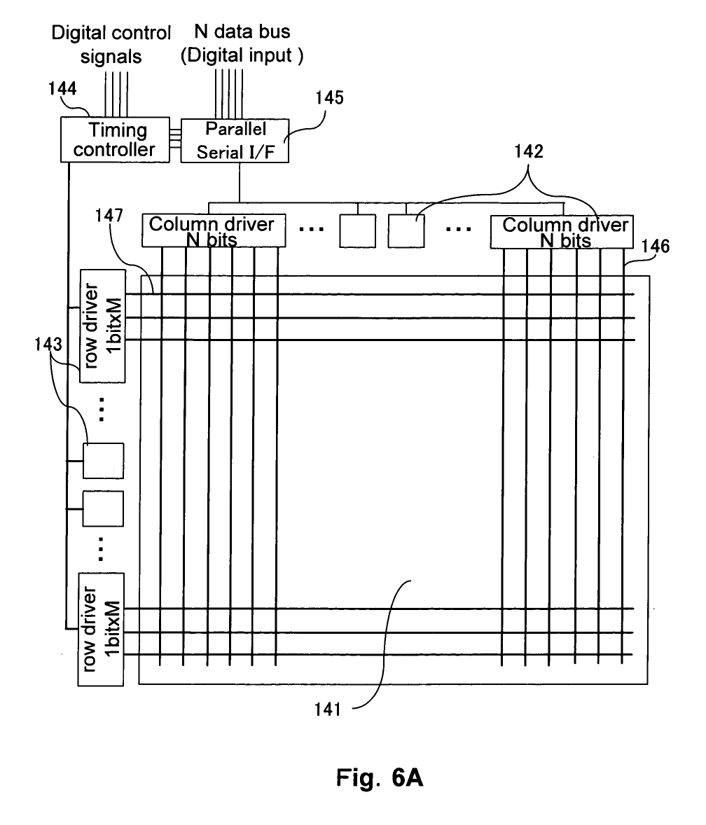

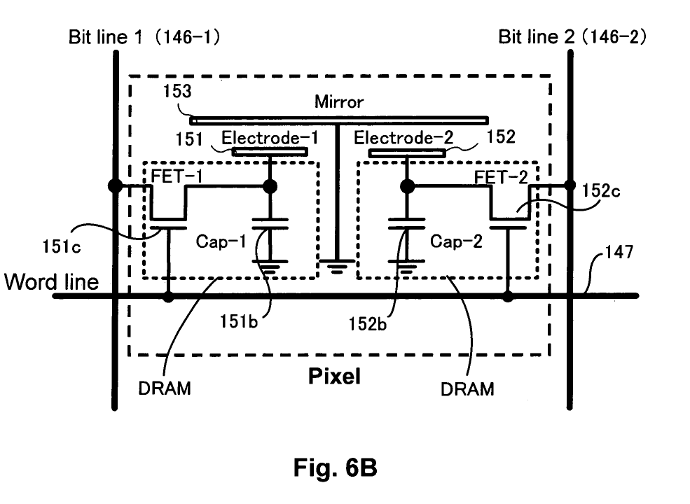

FIG. 6A is a functional block diagram of an SLM, and FIG. 6B is a control circuit diagram that executes a Digital Signal Control scheme.

In the above described image display device, according to the preferred embodiment of the present invention, the controlling unit can be also configured to control the deflective modulation element with a digital control signal.

With the image display device having such a configuration, the oscillating state can be controlled by using non-binary data as a digital signal, without converting the digital signal into an analog signal with a D/A converter, etc. Performing the control by using non-binary data as a digital signal in this way is preferable in that it is not practical to configure the device with D/A converters, the number of which is equal to the number of bit lines (see FIG. 6B), when the pixel size of the deflective modulation element is increased.

FIG. 6A shows a layout example of the internal configuration of the SLM comprising the image display device having such a configuration. In FIG. 6A, the SLM (for example, the SLM 104) comprises a mirror element array 141, which is a deflective modulation element array, column drivers 142, row drivers 143, a timing controller 144, and a parallel/serial interface 145. The timing controller 144 controls the row drivers 143 based on a digital control signal (from, for example, the processor 105). The parallel/serial interface 145 inputs a digital signal (from, for example, the data converter 103), incoming as a parallel signal, into a serial signal and feeds the signal to the column drivers 142. In the mirror element array 141, a plurality of mirror elements are arranged in positions where a bit line 146, which extends from the column driver 142 in a vertical direction, intersects with a word line 147, which extends from the row driver 143 in the horizontal direction.

FIG. 6B is a conceptual diagram showing a configuration example of one of the mirror elements arrayed in the SLM. In FIG. 6B, an OFF capacitor 151b is connected to an OFF electrode 151 (corresponding, to the OFF electrode 115 of FIG. 3B) and also connected to a bit line 146-1 and a word line 147 via a gate transistor 151c. Additionally, an ON capacitor 152b is connected to an ON electrode 152 (corresponding to the ON electrode 116 of FIG. 3B) and also connected to a bit line 146-2 and the word line 147 via a gate transistor 152c. The opening/closing of the gate transistors 151c and 152c is controlled by the word line 147. Specifically, consecutive mirror elements in a row in an arbitrary word line 147 are simultaneously selected, and the charge/discharge of the OFF capacitor 151b and the ON capacitor 152b is controlled by the bit lines 146-1 and 146-2, and the ON/OFF states of the mirror 153 in each of the mirror elements in the row is individually controlled.

In the above described image display device, according to the preferred embodiment of the present invention, non-binary data is also configured to be decimal data. Additionally, in the above described image display device, the weighting factor of the least significant bit of binary data of at least N consecutive bits, which is converted into non-binary data, can be configured to be equal to the weighting factor of the smallest bit of the non-binary data, specifically, to make the display period of the least significant bit of the binary data of N bits equal to the smallest display period of the non-binary data. This is shown in the control example of FIG. 4B.

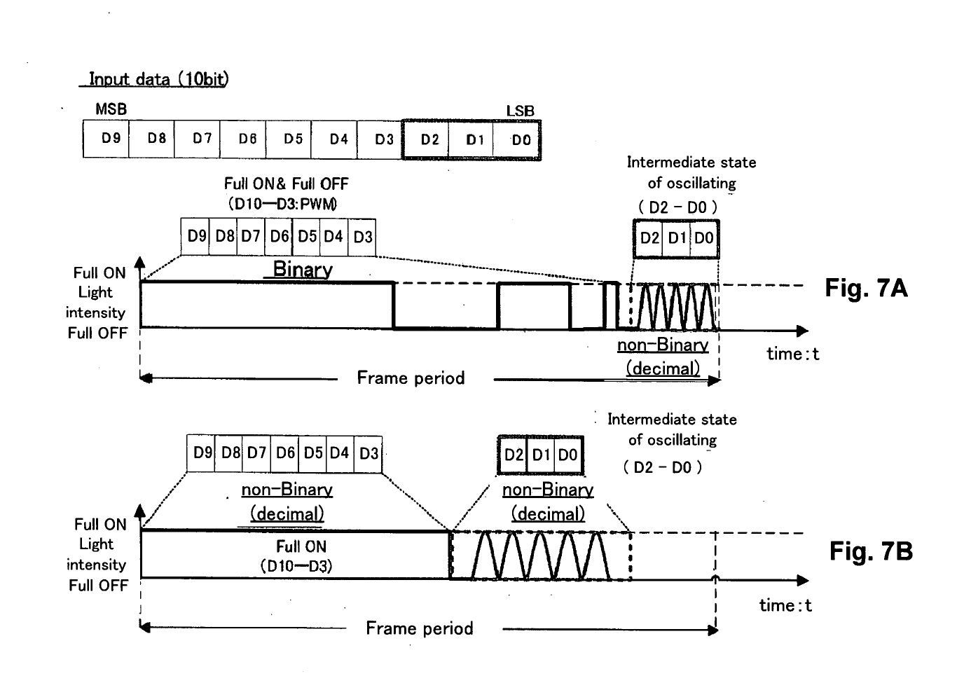

FIGS. 7A and 7B show another preferred embodiment, where the N bits represent the difference between the number of bits of incoming image signal and the number of bits to display in gray scale.

If the number of input bits of an image signal is different from that of display gray scales, the above described image display device can be also configured to implement at least N consecutive bits of binary data, which is converted into non-binary data used when the deflective modulation element is controlled to be in the oscillating state, as the number of bits of the difference between the number of input bits of the image signal and the number of bits of the display gray scales, or configured to include the number of bits of the difference.

FIG. 7A shows an example of controlling the projected light in one frame period in the image display device having such a configuration. Assuming that the number of input bits of an image signal and the number of bits of display gray scales are 10 and 7, respectively, the difference between them is 3 bits. In this case, at least 3 consecutive bits of the inputted binary data are converted into non-binary data, used when the deflective modulation element is controlled to be in the oscillating state. Additionally, the remaining bits of the inputted binary data are left unchanged as the binary data.

In the example shown in FIG. 7A, the lowest-order 3 bits of the inputted binary data are converted into non-binary data and the remaining 7 bits are left unchanged as the binary data. Then, the deflective modulation element is controlled to be in the fully ON direction or the fully OFF direction, according to the values of the bits left unchanged as the binary data and the weighting factors pre-assigned to these bits, or controlled to be in the oscillating state, according to the converted non-binary data. In this way, projected light in one frame period is controlled. Here, the non-binary data can be also implemented, for example, as decimal data.

FIG. 7B shows another example of control in a case where the difference between the number of input bits of an image signal and the number of bits of display gray scales is 3, similar to the example shown in FIG. 7A. In this control example, the entirety of the inputted binary data is converted into non-binary data to control the deflection state of the deflective modulation element. Note that the deflective modulation element is controlled to be fully ON, according to the non-binary data converted from the highest-order 7 bits of the inputted binary data and controlled to be in the oscillating state, according to non-binary data converted from the lowest-order 3 bits of the inputted binary data. Here, the non-binary data can be also implemented, for example, as decimal data.

In the above described image display device according to the preferred embodiment of the present invention, the intensity distribution of illuminating light can be also made non-uniform. Furthermore, the above described image display device can be also configured to change the light intensity or the intensity distribution of the illuminating light, when a control according to non-binary data is performed.

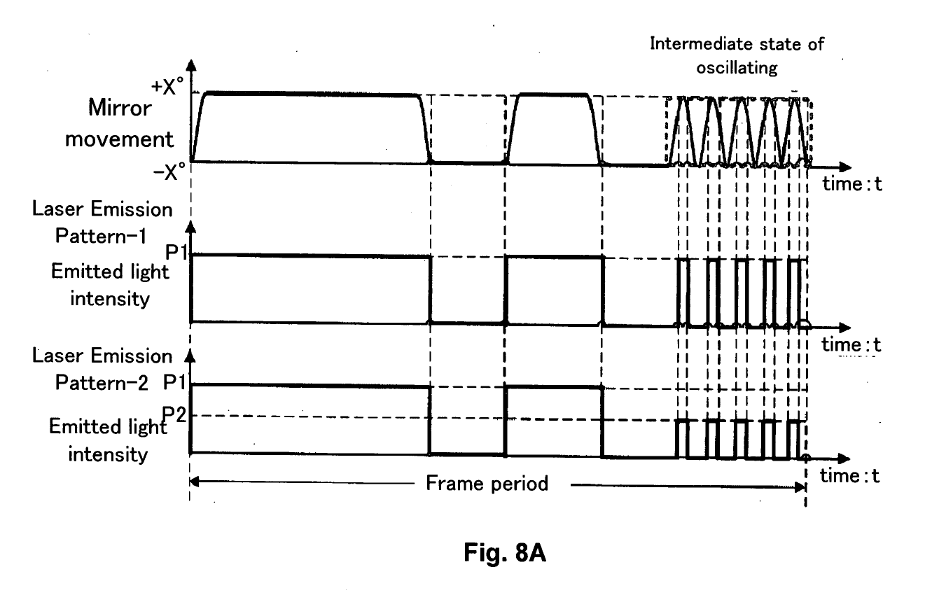

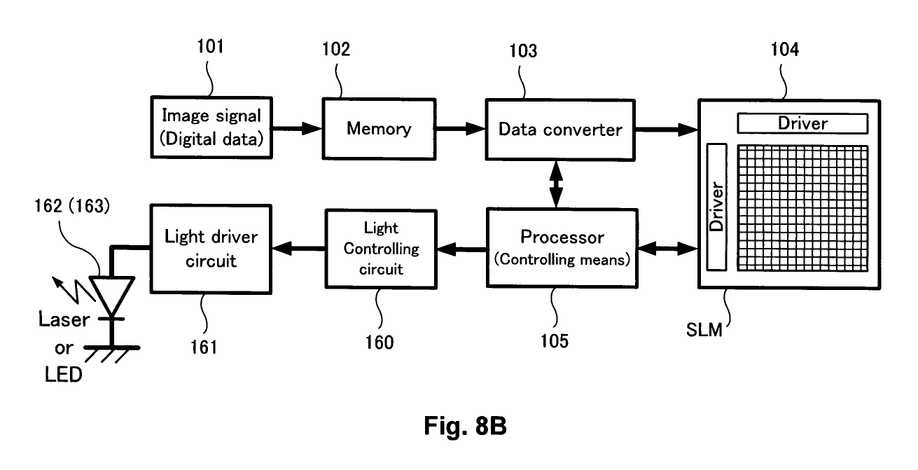

FIG. 8A is a pulse width diagram of a control signal for an SLM, with corresponding light intensity in a frame period, and FIG. 8B is a control circuit diagram that implements illumination light from a semiconductor laser source or LED light source.

The above described image display device, according to the preferred embodiment of the present invention, can be also configured to implement the illumination light as light from a semiconductor laser light source, or light from an LED light source.

FIG. 8A shows an example of controlling the projected light in one frame period in the image display device having such a configuration. In FIG. 8A, the operations of the mirror element, is shown in the top section, and examples of two different patterns of light emission made by a semiconductor laser light source are shown in the middle and bottom sections. In the image display device, according to this preferred embodiment, part of the inputted binary data is converted into non-binary data, and the remaining binary data is left unchanged as the binary data. As shown in the top section of FIG. 8A, the deflection state of the mirror element is controlled to be in the fully ON direction (+X^{o}) or the fully OFF direction (−X^{o}) according to the remaining binary data, and controlled to be the oscillating state (+X^{o}˜−X^{o}) according to the non-binary data. Additionally, as shown in the middle and bottom sections of FIG. 8A, the intensity of output light and the light emission time of the semiconductor laser light source are controlled simultaneously with the deflection state of the mirror element. Note that in the example of the light emission pattern shown in the bottom section of FIG. 8A, the intensity of output light when the mirror element is controlled in the oscillating state is less than that in the light emission pattern shown in the middle section.

The system configuration example shown in FIG. 8B is a configuration implemented by adding a light source controlling circuit 160, a light source driving circuit 161, and a semiconductor laser light source 162 or an LED light source 163 to the system configuration example shown in FIG. 3A. The light source controlling circuit 160 controls the light source driving circuit 161 under the control of the processor 105. The light source driving circuit 161 drives the semiconductor laser light source 162 or the LED light source 163, which serves as the source of the illumination light, under the control of the light source controlling circuit 160. With such a configuration, the control of the mirror element and the light emission patterns shown in FIG. 8A can be performed.

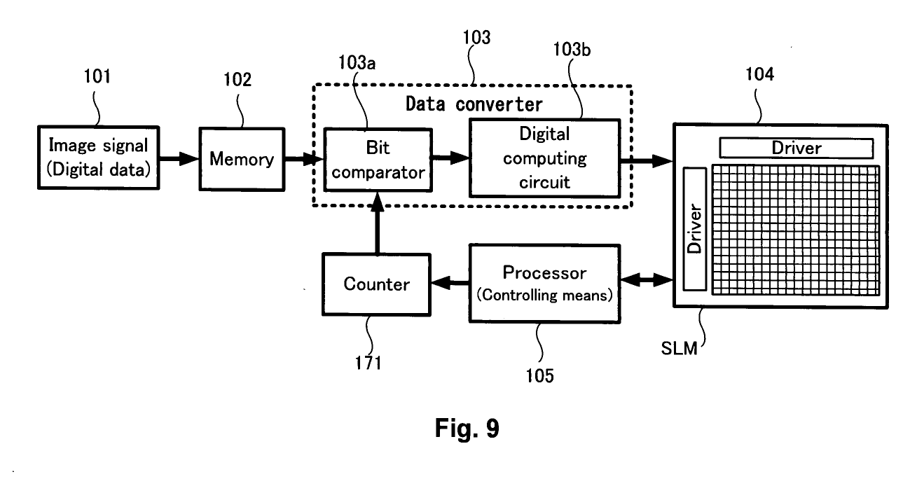

FIG. 9 is a digital circuit diagram to carry out a function of non-binary data conversion process. In the above described image display device, according to the preferred embodiment of the present invention, the data converting unit can be configured with a digital circuit.

The system configuration example shown in FIG. 9 is a configuration implemented by adding a counter 171 to the above described system configuration example shown in FIG. 3A, and by making the data converter 103 comprise a bit comparator 103a and a digital computing circuit 103b, as digital circuits. The counter 171 performs a count operation under the control of the processor 105. The bit comparator 103a makes a comparison between the inputted binary data and the count value of the counter 171, and outputs the result of the comparison to the digital computing circuit 103b as a digital signal of “H(1)” or “L(0)”. The digital computing circuit 103b generates non-binary data from the result of the comparison made by the bit comparator 103a with a digital computation process and outputs the generated data.

In the above described image display device, the data converting unit can also be configured to have a correction function on an image signal and to convert the image signal into non-binary data, on which a correction made by the correction function is reflected. Here, the correction function is, for example, a function to make a γ removal or a γ correction of the image signal. Or, the correction function may correct the intensity or the intensity distribution of light modulated by the deflective modulation element. Alternately, the correction function may also make visual corrections of an image signal, such as a quantization error in image signal processing, an error of opto-electric conversion made by the deflective modulation element, a uniformity error and the false contour of illuminating light, dithering, IP conversion (Interlace Progressive conversion), scaling, a dynamic range change, etc.

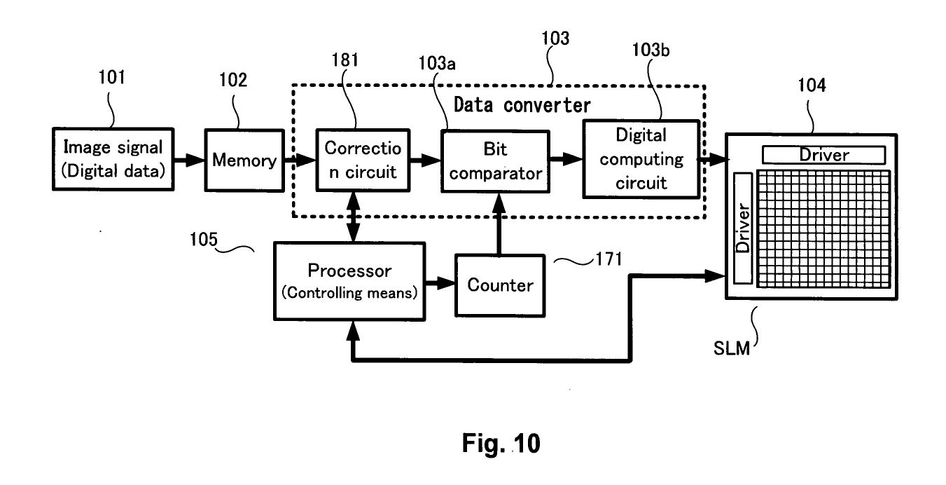

FIG. 10 shows a system configuration example of the image display device having such a configuration. The system configuration example shown in FIG. 10 is a configuration implemented by further comprising the data converter 103 with a correction circuit 181 in the system configuration example shown in FIG. 9. The correction circuit 181 makes the above described corrections to the inputted binary data under the control of the processor 105, and outputs the corrected binary data to the bit comparator 103a in the next step.

In the above described image display device, the data converting unit can also be configured to have a gray scale conversion function to improve the gray scale of binary data. Here, the gray scale conversion function is, for example, a function to convert 8-bit binary data into 10-bit binary data.

In the above described image display device, non-binary data, which is converted by the data converting unit, can also be configured to be directly transferred to the SLM, or transferred to the SLM via a memory. If the non-binary data is transferred via a memory, it is preferable that the memory has a capacity equivalent to or greater than the number of deflective modulation elements of the SLM.

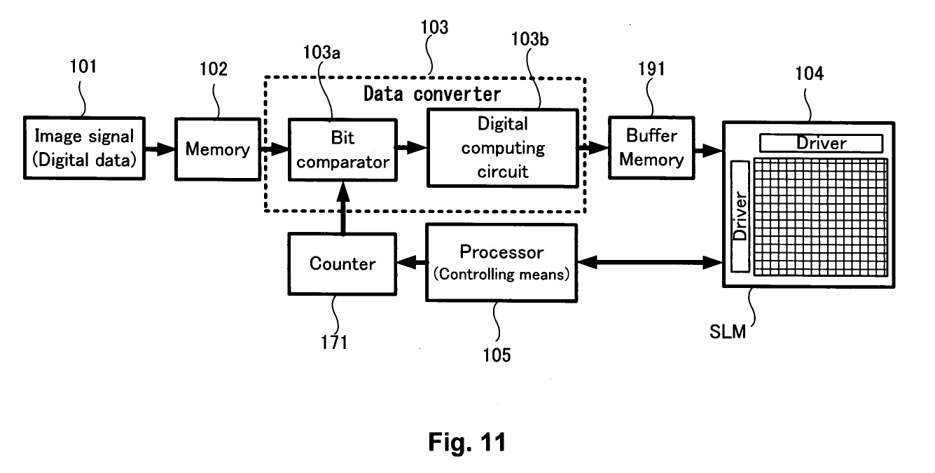

FIG. 11 shows a system configuration example of an image display device configured to transfer non-binary data via a memory. In FIG. 11, the system configuration example shown in FIG. 9 is further comprised of a buffer memory 191 between the data converter 103 and the SLM 104. With this configuration, non-binary data converted by the data converter 103 is transferred to the SLM 104 via the buffer memory 191. It is preferable that the buffer memory 191 has a capacity equivalent to or greater than the number of deflective modulation elements which are comprised in the SLM 104. The capacity of the buffer memory 191 can be reduced according to the processing speed of the data converter 103 and the display rate of the SLM 104.

In the above described image display device, according to the preferred embodiment of the present invention, the controlling unit can also be configured to feed a mode signal, for determining the deflection state of the deflective modulation element, to the SLM.

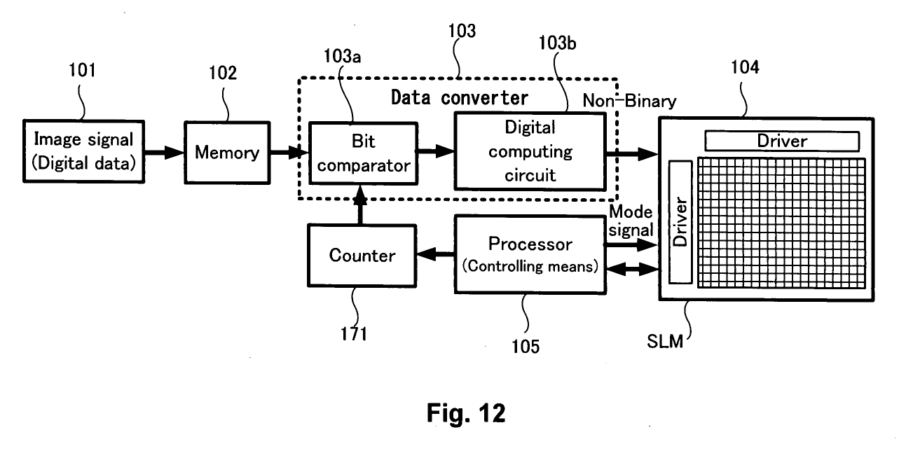

FIG. 12 shows a system configuration example of the image display device having such a configuration. In FIG. 12, the system configuration example shown in FIG. 9 is further configured by causing the processor 105 to feed the mode signal to the SLM 104. With this configuration, the deflection states of the deflective modulation elements in the SLM 104 are controlled according to the mode signal and non-binary data converted by the data converter 103. As a result, data to be transferred to the ON capacitor 152b and/or the OFF capacitor 151b of each mirror element in the SLM 104 is fed from the data converter 103 to the SLM 104, whereby the deflection state of the deflective modulation element can be controlled, and the amount of fed data can be reduced.

The above described image display device according to the preferred embodiment of the present invention can be also configured as a single-panel image display device comprising one SLM, or a multi-panel image display device comprising a plurality of SLMs.

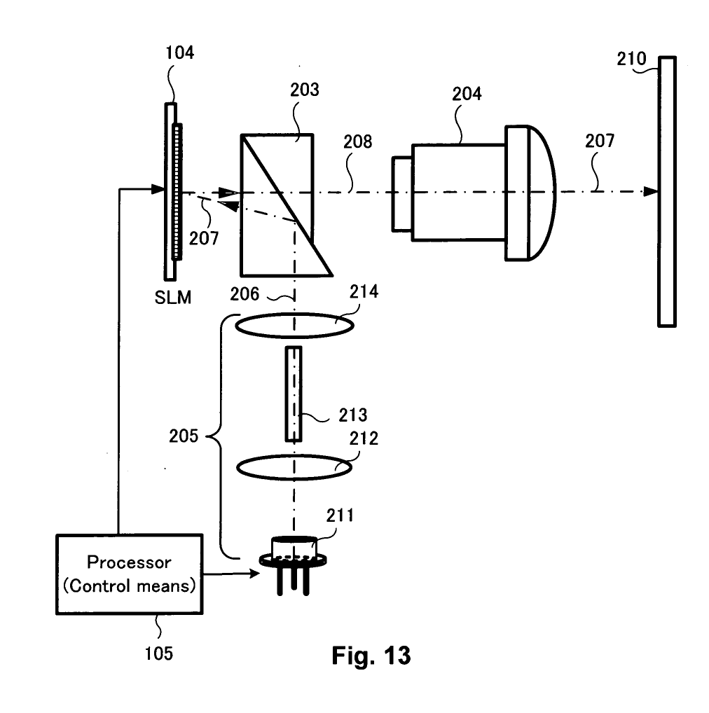

FIG. 13 shows an optical configuration example of a single-panel image display device according to a preferred embodiment of the present invention. In FIG. 13, the single-panel image display device comprises one SLM 104, a processor 105, a TIR (Total Internal Reflection) prism 203, a projection optical system 204, and a light source optical system 205. The SLM 104 and the TIR prism 203 are arranged on the optical axis of the projection optical system 204, and the light source optical system 205 is arranged so that its optical axis is orthogonal to that of the projection optical system 204.

The TIR prism 203 directs the illumination light 206, which is incident from the light source optical system 205, to the SLM 104 at a predetermined tilt angle as incident light 207. The TIR prism 203 further directs the reflection light 208, reflected by the SLM 104, towards the projection optical system 204. The projection optical system 204 projects the reflection light 208, incoming via the SLM 104 and the TIR prism 203, onto a screen 210 as projected light 209.

The light source optical system 205 includes a variable light source 211 for generating the illumination light 206, a condenser lens 212, for concentrating the illumination light 206, a rod integrator 213, and a condenser lens 214. The variable light source 211, the condenser lens 212, the rod integrator 213, and the condenser lens 214 are arranged on the optical axis of the illumination light 206, which is emitted from the variable light source 211 and incident to the side of the TIR prism 203.

In the optical configuration example shown in FIG. 13, a color display on the screen 210 can be projected with a color sequential method by using one SLM 104. In this case, the variable light source 211 is configured with a red laser light source, a green laser light source, and a blue laser light source, the light emission states of which can be independently controlled. One frame of display data is divided into a plurality of sub-fields (3 sub-fields respectively corresponding to R (Red), G (Green), and B (Blue) in this case), and the red, green, and blue laser light sources sequentially emit light for durations corresponding to the sub-fields of each color.

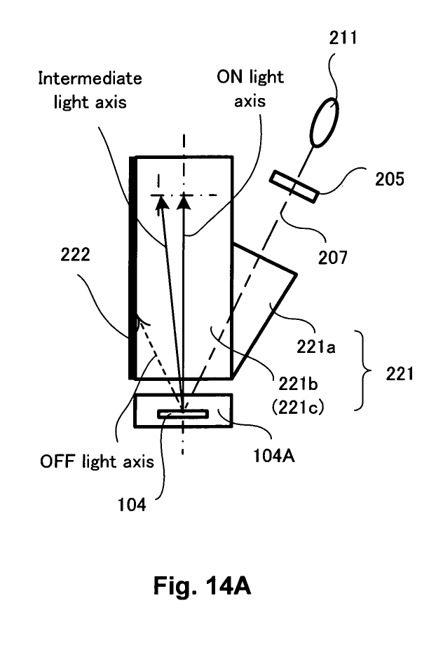

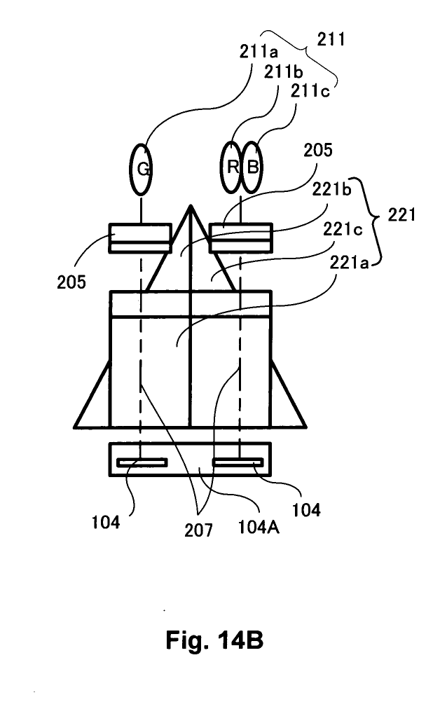

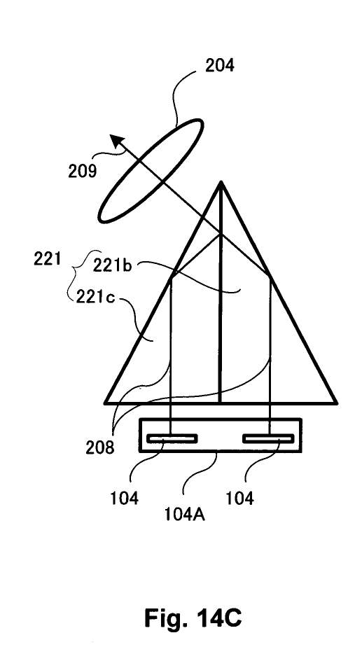

FIGS. 14A, 14B, and 14C show an optical configuration example of a two-panel image display device according to a preferred embodiment of the present invention. FIG. 14A is the side view; FIG. 14B is the front view; and FIG. 14C is the rear view. In FIGS. 14A, 14B, and 14C, the same constituent elements as those shown in FIG. 13 are denoted with the same reference numerals. However, the variable light source 211 is depicted independently of the light source optical system 205 in this example.

The optical configuration example shown in FIGS. 14A, 14B, and 14C includes a device package 104A, where two SLMs 104 are mounted together, a color synthesis optical system 221, a light source optical system 205, and a variable light source 211. The two SLMs mounted in the device package 104A are fixed so that their rectangular outlines tilt almost at 45 degrees on a horizontal plane with reference to each side of the rectangular device package 104A.

Above the device package 104A, the color synthesis optical system 221 is arranged. The color synthesis optical system 221 is composed of prisms 221b and 221c, right-angled triangular columns, which are joined to form a triangle in which the two hypotenuses are equal, and an optical guide block 221a, in the form of a right-angled triangle joined on its hypotenuse to the hypotenuses of the prisms 221b and 221c. In the prisms 221b and 221c, a light absorber 222 is provided on the side opposite the side on which the optical guide block 221a is joined. On the bottom of the optical guide block 221a, a light source optical system 205 of a green laser light source 211a and a light source optical system 205 of a red laser light source 211b and a blue laser light source 211c are provided with their optical axes vertical to the bottom of the optical guide block 221a.

Illumination light emitted from the green laser light source 211a is incident, as incident light 207, to one of the SLMs 104, which is positioned immediately below the prism 221b, via the optical guide block 221a and the prism 221b. Illumination lights emitted from the red laser light source 221b and the blue laser light source 211c are incident, as incident lights 207, to the other SLM 104, which is positioned immediately below the prism 221c, via the optical guide block 221a and the prism 221c.

When the deflective modulation element is in the fully ON state, the red and the blue incident lights 207, incident to the SLM 104, are reflected within the prism 221c vertically upward as reflection light 208, further reflected on the outer side of the prism 221c and the joining face, are incident to the projection optical system 204, and result in projected light 209. When the deflective modulation element is in the fully ON state, the green incident light 207, incident to the SLM 104, is reflected within the prism 221b vertically upward as reflection light 208, further reflected on the outer side of the prism 221b, and is incident to the projection optical system 204 with the same optical path as the green and the blue reflection light 208, resulting in the projection light 209.

As described above, in the optical configuration example shown in FIGS. 14A, 14B, and 14C, the incident light 207 from the green laser light source 211a is irradiated onto one of the SLMs 104 included in the device package 104A. The incident light 207 from either or both of the red laser light source 211b and the blue laser slight source 211c is irradiated onto the other SLM 104. The lights respectively modulated by the two SLMs 104 are concentrated within the color synthesis optical system 221, enlarged by the projection optical system 204, and projected onto a screen as projected light 209, as described above.

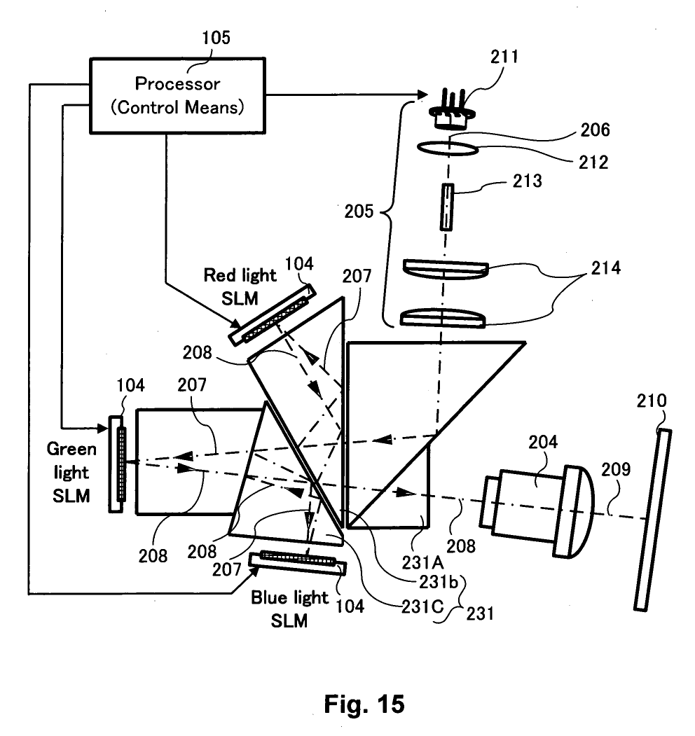

FIG. 15 shows an optical configuration example of a three-panel image display device according to a preferred embodiment of the present invention. Also in FIG. 15, the same constituent elements as those shown in FIG. 13 are denoted with the same reference numerals. The three-panel image display device according to this preferred embodiment comprises three SLMs 104, and a light separation/synthesis optical system 231 is arranged between the projection optical system 204 and each of the three SLMs 104.

The light separation/synthesis optical system 231 is composed of three TIR prisms 231a, 231b, and 231c. The TIR prism 231a guides the illumination light 206, which is incident from the side face of the optical axis of the projection optical system 204, to the side of the SLM 104 as incident light 207. The TIR prism 231b separates red (R) light from the incident light 207, incoming via the TIR prism 231a, and directs the red reflection light 208 to the TIR prism 231 a. Similarly, the TIR prism 231c separates blue (B) and green (G) lights from the incident light 207, incoming via the TIR prism 213a, and directs their reflection lights 208 to the TIR prism 231a. Accordingly, spatial light modulations for the three colors R, G, and B are simultaneously modulated, and the reflection lights 208, resultant from the modulations, become projected light 209 via the projection optical system 204 and are projected onto the screen 210 as a color display.

Although the present invention has been described in terms of the presently preferred embodiment, it is to be understood that such disclosures are not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

What is claimed is:

1. An image display system for displaying an image according to an input image signal, comprising:
a light source for emitting an illumination light;
a data converting circuit for receiving and converting the input image signal into non-binary data;
a spatial light modulator for receiving and applying the non-binary data for modulating the illumination light;
a light source control circuit for applying the non-binary data in coordination with the spatial light modulator for controlling the light source.

2. The image display system according to claim 1, wherein:
the data converting circuit converts at least N consecutive bits of the input image signal into non-binary data, where N is a positive integer.

3. The image display system according to claim 1, wherein:
the light source control circuit applies a bit arrangement or a bit weight scale of the non-binary data to control the light source.

4. The image display system according to claim 1, wherein:
the light source control circuit controls the light source by controlling and adjusting at least a light source emission intensity, an emission period, an emission frequency or an emission timing.

5. The image display system according to claim 1, wherein:
the light source control circuit controls emission pulses of the illumination light by controlling and adjusting at least a pulse amplitude, a pulse width, a pulse frequency or a number of emission pulse.

6. The image display system according to claim 1, wherein:
the data converting circuit further converts the input image signal into the non-binary data applying the same weight to at least three bits of the non-binary data.

7. The image display system according to claim 1, wherein:
the data converting circuit further converts the input image signal into the non-binary data applying the same value to at least two consecutive bits of the non-binary data.

8. The image display system according to claim 1, wherein:
the data converting circuit further carries out a correction function for correcting the input image signal.

9. The image display system according to claim 8, wherein:
the data converting circuit further carries out the correction function by performing a γ removal or a γ correction of the image signal.

10. An image display system, comprising:
a light source for emitting an illumination light;
a data conversion circuit for receiving and converting several bits of input image data into an output data;
a spatial light modulator for modulating the illumination light;
a control circuit for receiving and applying the output signal for controlling the light source and the spatial light modulator.

11. The image display system according to claim 10, wherein:
the data conversion circuit converting the input image data into the output signal comprising non-binary data.

12. The image display system according to claim 10, wherein:
the spatial light modulator comprises a plurality of deflective modulation elements controllable to operate in at least three states.

13. The image display system according to claim 12, wherein:
the control circuit controls and adjusts the light source in coordination with a control process for controlling the deflective modulation elements to operate in the three states.

14. An image display system, comprising:
a light source for emitting an illumination light;
a data conversion circuit for receiving and converting an input image data into non-binary data;
a spatial light modulator for receiving and applying the non-binary data for modulating the illumination light;
a control circuit for receiving and applying the non-binary data to control the spatial light modulator; and
a light source control circuit receives and applies a clock signal synchronous with a reference clock signal used for converting the input image data for controlling the light source.

15. The image display system according to claim 14, wherein:
the light source emitting the illumination light comprising a plurality of different colors, and
the light source control circuit further controls the light source with different reference clock signals to emit the illumination light comprising each of the different colors.
